(19) United States
(12) Patent Application Publication
(10) Pub. No.: US 2006/0132843 A1
(43) Pub. Date: Jun. 22, 2006

(54) Image forming method and apparatus for printing image data received from external storage device

(75) Inventors: Song-baik Jim, Seoul (KR); Byung-tae Kang, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/302,377

(22) Filed: Dec. 14, 2005

(30) Foreign Application Priority Data
Dec. 15, 2004 (KR) 2004-0106541
May 6, 2005 (KR) 2005-0037847

(51) Int. Cl. G06F 3/12

(52) U.S. Cl. 358/1.15

(57) ABSTRACT

An image forming method and apparatus are provided for receiving a portable document format (PDF) or post script (PS) file including image data from an external storage device, such as a universal serial bus memory stick, and printing the image data without using a personal computer. The image forming method includes a file storing image data received from the external storage device. Print page information is displayed regarding a plurality of pages of the image data. Information is received regarding one of the plurality of pages chosen to be printed by a user. The image data is printed corresponding to the chosen page. Accordingly, paper wastage is reduced and user convenience is increased by allowing the selecting and printing in units of pages or contents part of a document stored in a PDF or PS file received from an external storage device.

### BACKGROUND OF THE INVENTION

This application claims the benefit under 35 U.S.C. § 119(a) of Korean Patent Application No. 10-2004-106541, filed on Dec. 15, 2004, in the Korean Intellectual Property Office and Korean Patent Application No. 10-2005-0037847, filled on May 6, 2005, in the Korean Intellectual Property Office, the entire disclosures of all two of which are hereby incorporated by reference.

### FIELD OF THE INVENTION

The present invention relates to an image forming method and apparatus for receiving a portable document format (PDF), post script (PS) file, or the like including image data from an external storage device, such as a universal serial bus memory (USB) stick, and printing the image data without using a personal computer (PC). More particularly, the present invention relates to an image forming method and apparatus that enables only part of a document, such as a PDF or PS file, stored in an input file from an external storage device to be selected and printed in units of pages or contents.

### DESCRIPTION OF THE RELATED ART

Image forming apparatuses convert a document written by a user using an application program or a picture taken by the user with a digital camera into data and output the data in such a manner that the data can be seen by the user.

Recently, an image forming apparatus has been developed which can directly connect to a digital camera that store image data in a memory card (that is, a smart card) installed therein via a (USB) without using a host (that is, a PC) and receive image data to be printed from a memory card that is attachable thereto or detachable therefrom.

Conventionally, when printing an image by providing a print command to an image forming apparatus using a PC, any part of a document can be selected and then printed using a print zone setting menu provided by an application program. However, when printing image data received from an external storage device, such as a memory card, USB storage device, or the like, it is impossible to choose a desired portion of a document and preferably print the desired portion of the document. Therefore, a user must print the entire document without an option to print only part of a document.

Accordingly, there is a need for an improved image forming method and apparatus that enables a user to select a desired portion of a document stored in an input file from an external storage device and preferably print the desired portion in units of pages or contents.

### SUMMARY OF THE INVENTION

An aspect of embodiments of the present invention is to address at least the above problems and/or disadvantages and to provide at least the advantages described below. Accordingly, an aspect of embodiments of the present invention is to provide an image forming method and apparatus that enable preferably part of a document stored as a PDF or PS file received from an external storage device to be selected and printed in units of pages or contents.

According to an aspect of exemplary embodiments of the present invention, there is provided an image forming method in which image data is received from an external storage device and then printed. The image forming method includes receiving a file storing image data from the external storage device. Print page information is displayed regarding a plurality of pages of the image data Information is received regarding one page chosen from the plurality of pages to be printed by a user The image data is printed corresponding to the chosen page.

The received file in the image forming method may be one of a portable document format (PDF) file, a postscript (PS) file, or a tagged image file format (TIFF) file.

The displaying in the image forming method may include detecting the print page information from the received file with reference to index information included in the received file and displaying the print page information.

The printing in the image forming method may include extracting the image data corresponding to the chosen page from the received file with reference to the index information, converting the extracted image data into print data that can be printed, and printing the print data.

The displaying in the image forming method may further include converting all of the image data stored in the received file into print data that can be printed, detecting print page information from the print data and displaying the detected print page information.

The printing in the image forming method may further include extracting print data corresponding to the chosen page from the entire print data, and printing the extracted print data.

The detecting in the image forming method may include detecting contents information regarding contents of the image data and page information regarding each of the contents.

The receiving of the information regarding the chosen page in the image forming method may include receiving information regarding one of the contents of the image data chosen to be printed by the user.

According to another aspect of exemplary embodiments of the present invention, there is provided an image forming apparatus which receives image data from an external storage device and prints the received image data. The image forming apparatus includes an interface unit which receives a file storing image data from the external storage device A display unit is included, which displays print page information regarding a plurality of pages of the image data A user input unit is also included, which receives information regarding one page chosen from the plurality pages to be printed by a user A control unit is further included, which detects the print page information from the received file, outputs the detected print page information to the display unit, and converts image data corresponding to the chosen page into print data that can be printed. A printing unit prints the print data.

The received file in the image forming apparatus may be one of a portable document format (PDF) file, a postscript (PS) file, or a tagged image file format (TIFF) file.

The control unit in the image forming apparatus may include a page information detector which detects the print page information from the received file with reference to index information included in the received file and displaying the print page information, and a renderer which extracts the image data corresponding to the chosen page from the received file with reference to the index information and converts the extracted image data into print data that can be printed.

The control unit may further include a renderer which converts all of the image data stored in the received file into print data that can be printed, a page information detector which detects print page information from the print data and displays the detected print page information, and a print data extractor which extracts print data corresponding to the chosen page from the entire print data.

The control unit may also determine whether the received file includes index information, detect the print page information directly from the image data if the received file is determined as including the index information, and convert all of the image data into print data that can be printed and then detects the print page information from the print data if the received file is determined as not including the index information.

According to another aspect of exemplary embodiments of the present invention, there is provided a computer-readable recording medium for storing a program enabling the image forming method.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a block diagram of an image forming apparatus according to an exemplary embodiment of the present invention;

FIG. 2 is a detailed block diagram of a control unit of FIG. 1;

FIG. 3 is a flowchart of an image forming method according to an exemplary embodiment of the present invention; and

FIG. 4 is a flowchart illustrating the operation of the control unit of FIG. 1.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

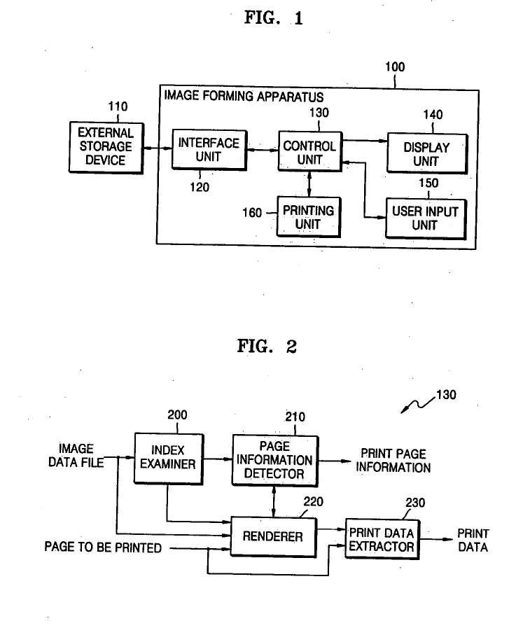

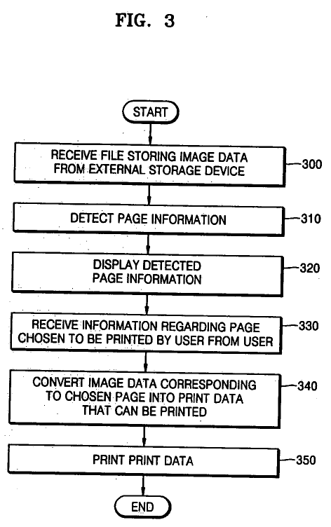

FIG. 1 is a block diagram of an image forming apparatus 100 according to an exemplary embodiment of the present invention. Referring to FIG. 1, the image forming apparatus 100 includes an interface unit 120, a control unit 130, a display unit 140, a user input unit 150, and a printing unit 160. The operation of the image forming apparatus 100 will now be described in detail with reference to FIG. 3, which is a flowchart illustrating an image forming method according to an exemplary embodiment of the present invention.

Referring to FIGS. 1 and 3, in operation 300, the interface unit 120 receives a file including image data to be printed from an external storage device 110. The external storage device 110 may be a memory card, such as, a smart card, which is attachable to or detachable from the interface unit 110, a USB storage device connected to the interface unit 120 via a USB, a digital camera, a digital camcorder, a mobile phone, a digital versatile disc (DVD) player that includes a memory, or with any other suitable device or method. The file received by the interface unit 120 in operation 300 may be a PDF file, a PS file, a tagged image file format (TIFF) file, or the like.

In operation 310, the control unit 130 receives the file received by the interface unit 120 and page information regarding a plurality of pages of a document stored in the received file. The control unit 130 may also detect contents information regarding the document stored in the received file.

In operation 320, the display unit 140 receives the page information from the control unit 130 and displays the page information on a screen of, for example, a liquid crystal display (LCD) device. In operation 330, a user determines which of the pages of the document stored in the received file is to be printed with reference to the page information, and the user input unit 150 receives information regarding the chosen page. If the display unit 140 displays the contents information, the user may determine which part of the document stored in the received file is to be printed with reference to the contents information.

In operation 340, the control unit 130 receives the information regarding the chosen page from the user input unit 150, extracts image data corresponding to the chosen page from the received file, and converts the image data into print data having a format compatible with the printing unit 160. In operation 350, the printing unit 160 prints the print data received from the control unit 130.

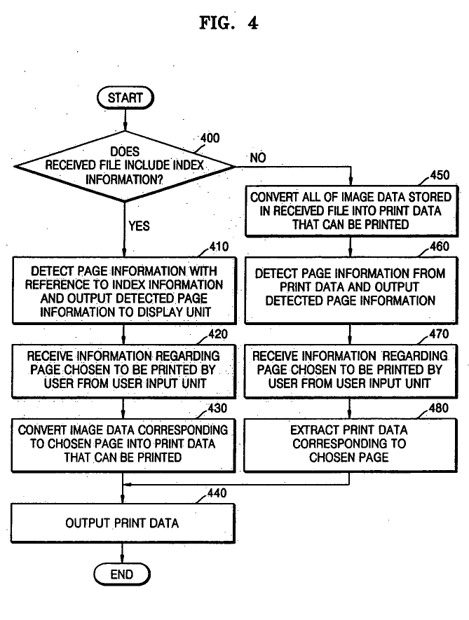

FIG. 2 is a detailed block diagram of the control unit 130 of FIG. 1. Referring to FIG. 2, the control unit 130 includes an index examiner 200, a page information detector 210, a renderer 220, and a print data extractor 230. The operation of the control unit 130 will be described later in detail with reference to FIG. 4.

The PDF is a file format developed to ensure compatibility among various computing platforms. The PDF enables a user to view documents written using various application programs regardless of the type of computing platform or application program that the user currently uses. A PDF document contains information on fonts used and images inserted therein. As a result, the PDF document is independent from other types of documents. A PDF document may also include index information, hyperlink information, such as URL information, and bookmark information used for moving between a plurality of pages of the PDF document which enables a user to easily and conveniently search for or move between the pages. If the PDF document includes index information, the control unit may easily detect page information regarding the plurality of pages of the document included in the PDF file with reference to the index information. However, the control unit 130 may not be able to detect the page information until looking over the entire document included in the PDF file.

In a PS file, a showpage PS command is generated for every few pages of a document. Therefore, the control unit 130 may parse the showpage PS command and detect page information regarding the document with reference to the parsed result.

Referring to FIGS. 1, 2, and 4, in operation 400, the index examiner 200 determines whether a file received by the interface unit 120 includes index information that comprises page information regarding a document included in the received file. If the received file is a PS file, the index examiner 200 may detect a showpage PS command from the PS file in operation 400.

In operation 410, if the received file is determined as including index information, the page information detector 210 detects page information regarding the document with reference to the index information and outputs the page information to the display unit 140. In operation 420, the renderer 220 receives information regarding a page of the document chosen by a user from the user input unit 150. In operation 430, the renderer 220 extracts image data corresponding to the chosen page from the received file and converts the image data into print data that can be printed by the printing unit 160. In operation 440, the print data extractor 230 transmits the print data obtained in operation 430 to the printing unit 160.

In operation 450, if the received file is determined as not including index information, the renderer 220 converts the entire image data stored in the received file into print data that can be printed by the printing unit 160. In operation 460, the page information extractor 210 receives the print data obtained in operation 450 from the renderer 220, detects page information regarding the document from the received file with reference to the print data obtained in operation 450, and outputs the page information to the display unit 140.

In operation 470, the print data extractor 230 receives the information regarding the chosen page from the user input unit 150. In operation 480, the print data extractor 230 extracts print data corresponding to the chosen page from the entire print data obtained in operation 450. In operation 440, the print data extractor 230 outputs the print data obtained in operation 480 to the printing unit 160.

The present invention can be realized as computer-readable codes written on a computer-readable recording medium. The computer-readable recording medium may include recording devices, such as, a ROM, a RAM, a CD-ROM, a magnetic tape, a floppy disk, an optical data storage, a carrier wave (that is, data transmission through the Internet), or any other suitable device or method.

In exemplary embodiments of the present invention, the receiving PDF files from an external storage device and printing the received PDF files have been described. However, embodiments of the present invention may also be implemented by receiving files other than PDF files from an external storage device and printing the received files, as long as the received files include contents information and page information regarding documents contained therein.

According to exemplary embodiments of the present invention, it is possible to reduce paper wastage and increase user convenience for printing image data by allowing the selecting and printing in units of pages or contents part of a document stored in a PDF file, PS file, or the like, received from an external storage device.

While the present invention has been shown and described with reference to exemplary embodiments thereof, it will be understood by those skilled in the art that various changes in form and detail may be made therein without departing from the spirit and scope of the invention as defined by the appended claims.

1. An image forming method in which image data is received from an external storage device and then printed, the image forming method comprising the steps of:
receiving a file storing image data from the external storage device;
displaying print page information regarding a plurality of pages of the image data;
receiving information regarding one page chosen from the plurality of pages to be printed by a user; and
printing image data corresponding to the chosen page.

2. The image forming method of claim 1, wherein the file storing image data comprises one of a portable document format (PDF) file, a postscript (PS) file, or a tagged image file format (TIFF) file.

3. The image forming method of claim 1, wherein the step of displaying comprises detecting the print page information from the received file with reference to index information included in the received file and displaying the print page information.

4. The image forming method of claim 3, wherein the step of printing comprises:
extracting the image data corresponding to the chosen page from the received file with reference to the index information;
converting the extracted image data into print data that can be printed; and
printing the print data.

5. The image forming method of claim 1, wherein the step of displaying comprises:
converting all of the image data stored in the received file into print data that can be printed; and
detecting print page information from the print data and displaying the detected print page information.

6. The image forming method of claim 5, wherein the step of printing comprises:
extracting print data corresponding to the chosen page from an entire print data; and
printing the extracted print data.

7. The image forming method of claim 3, wherein the step of detecting comprises detecting contents information regarding contents of the image data and page information regarding each of the contents.

8. The image forming method of claim 7, wherein the receiving of the information regarding the chosen page comprises receiving information regarding one of the contents of the image data chosen to be printed by the user.

9. An image forming apparatus which receives image data from an external storage device and prints the received image data, the image forming apparatus comprising:
an interface unit which receives a file storing image data from the external storage device;
a display unit which displays print page information regarding a plurality of pages of the image data;
a user input unit which receives information regarding one page chosen from the plurality of pages to be printed by a user;
a control unit which detects the print page information from the received file, outputs the detected print page information to the display unit, and converts image data corresponding to the chosen page into print data that can be printed; and
a printing unit which prints the print data.

10. The image forming apparatus of claim 9, wherein the received file comprises one of a portable document format (PDF) file, a postscript (PS) file, or a tagged image file format (TIFF) file.

11. The image forming apparatus of claim 9, wherein the control unit comprises:
a page information detector which detects the print page information from the received file with reference to index information included in the received file and displaying the print page information; and
a renderer which extracts the image data corresponding to the chosen page from the received file with reference to the index information and converts the extracted image data into print data that can be printed.

12. The image forming apparatus of claim 9, wherein the control unit comprises:
a renderer which converts all of the image data stored in the received file into print data that can be printed;
a page information detector which detects print page information from the print data and displays the detected print page information; and
a print data extractor which extracts print data corresponding to the chosen page from an entire print data.

13. The image forming apparatus of claim 9, wherein the control unit determines whether the received file includes index information, detects the print page information directly from the image data if the received file is determined as including the index information, and converts all of the image data into print data that can be printed and then detects the print page information from the print data if the received file is determined as not including the index information.

14. A computer-readable recording medium for storing a program to perform a method of receiving and printing image data from an external storage device, the method comprising the steps of:
receiving a file storing image data from the external storage device;
displaying print page information regarding a plurality of pages of the image data;
receiving information regarding one page chosen from the plurality of pages to be printed by a user;
converting image data corresponding to the chosen page into print data; and
printing image data corresponding to the chosen page.

15. The computer-readable recording medium of claim 14, wherein the received file is one of a portable document format (PDF) file, a postscript (PS) file, or a tagged image file format (TIFF) file.

16. The computer-readable recording medium of claim 14, wherein the step of displaying comprises:
detecting the print page information from the received file with reference to index information included in the received file, and displaying the print page information; and
extracting the image data corresponding to the chosen page from the received file with reference to the index information and converting the extracted image data into print data that can be printed.

17. The computer-readable recording medium of claim 14, wherein the step of printing comprises:
converting the extracted image data into print data that can be printed;
detecting print page information from the print data and displaying the detected print page information; and
extracting print data corresponding to the chosen page from an entire print data.

18. The computer-readable recording medium of claim 14, wherein the step of receiving comprises:
determining whether the file storing image data includes index information;
detecting the print page information directly from the image data if the file storing image data is determined as including the index information; and
converting all image data into print data that can be printed, and then detecting the print page information from the print data if the file storing image data is determined as not including the index information.

19. The image forming method of claim 5, wherein the step of detecting comprises detecting contents information regarding contents of the image data and page information regarding each of the contents.
